(19) United States
(12) Patent Application Publication
(10) Pub. No.: US 2021/0229176 A1
(43) Pub. Date: Jul. 29, 2021

(54) INCLUSION OF INDICIA IN ADDITIVE MANUFACTURING

(71) Applicant: UNIVERSITY OF LOUISVILLE RESEARCH FOUNDATION INC., Louisville, KY (US)

(72) Inventors: Edward Carl TACKETT, Louisville, KY (US); Timothy J. GORNET, Louisville, KY (US); Thomas L. STARR, Louisville, KY (US)

(21) Appl. No.: 15/734,783

(22) PCT Filed: Jun. 5, 2019
(86) PCT No.: PCT/US2019/035533

§ 371 Date: Dec. 3, 2020

Related U.S. Application Data
(60) Provisional application No. 62/680,636, filed on Jun. 5, 2018.

(51) Int. Cl. B22F 7/02; B22F 10/28; B33Y 10/00; B33Y 80/00

(52) U.S. Cl. CPC B22F 7/02; B33Y 80/00; B33Y 10/00; B22F 10/28

(57) ABSTRACT

An indicia or marker is embedded in an object that includes a plurality of layers of material such as in an object formed by additive manufacture by forming at least one layer of a prism in a layer of the object, wherein the layer of the prism includes an aperture in the form of an identifier. The prism is densified to a density distinct from that of the remainder of the object. The aperture in the layer of the prism is filled with a powder material; a portion of which is preferably densified to a density distinct from that of the object and/or the prism, leaving a margin to prevent mixing of the materials of the object, prism and/or identifier during densification.

### FIELD OF THE INVENTION

The present invention generally relates to objects manufactured by formation of successive layers and, more particularly, to formation of indicia within such objects.

### BACKGROUND OF THE INVENTION

Three-dimensional (3-D) printing has become widespread and relatively sophisticated during the last decade, particularly for prototyping of objects to be manufactured at relatively high volume by other processes. For example, 3-D printing can be used to develop an object of a given shape that can be fully examined and, if satisfactory, used to create a mold for corresponding objects to be made by, for example, injection molding. Numerous printable materials have also been developed to provide required properties in the objects made by the 3-D printing process and apparatus. Concurrent printing of more than one material is also known.

More recently, 3-D printing has been investigated for direct manufacturing of objects of a wide variety of materials; resulting in substantial increases in sophistication of apparatus for forming layers of desired and possibly exotic materials such as metals, alloys, plastics and ceramics having properties appropriate to such objects. The processes involved in formation of such layers of a given object by 3-D printing are collectively referred to as additive manufacturing. One known group of additive manufacturing processes that is applicable to a wide variety of materials is known as powder bed fusion which comprises steps of depositing a thin layer of material in the form of a fine powder on a surface, possibly with a binder, adhesive and/or flux, and then fusing the powder into a thin, continuous layer by application of energy such as by use of a laser, an electron beam, an electrical arc or other source of localized heat. Therefore, powder bed fusion is applicable to virtually any material that can be reduced to a fine powder and converted to a film by application of heat.

It is often desirable to provide markings or indicia of some type on a manufactured object even though provision of markings or indicia inherently adds to the operations necessary to the manufacture of the object and to the cost. Such indicia may be utilitarian such as scales on a measuring device. More commonly, indicia may reflect a source of origin or quality for the object, much in the manner of a trademark or to indicate particular features or properties of the object, such as maximum load for which it is designed. Certainty of identification is especially important for tracking object condition or performance over long periods of time such as monitoring implanted medical devices.

However, such indicia on the exterior of an object often fail to provide assurance of authenticity or other desired information since such indicia can generally be duplicated or applied relatively easily to an object from another source or of a different quality or material as is often the case for goods referred to as counterfeit. Conversely, indicia placed on the surface of an object are subject to being removed by abrasion, etching or the like during normal and routine use of the object or as an incident of some improper activity, such as removal or alteration of serial numbers on parts of automobiles, and indications of ownership such as initials engraved on jewelry. Therefore, while visible indicia on the surface of objects may be desirable for a number of purposes, they are not ideally suited to the purposes for which they may be desired.

### SUMMARY OF THE INVENTION

It is therefore an object of the present invention to provide a method and apparatus for forming indicia in situ within the body of an object produced by additive manufacturing during the fabrication of the object which can be readily perceived by known and readily available or foreseeable imaging techniques or destructive or non-destructive testing and which can provide all of the functions of visible surface indicia as well as other desirable functions.

It is another object of the invention to provide markings or indicia within an object that are difficult to duplicate and otherwise improve confirmation of authenticity, origin and block-chain tracking and prevention of counterfeiting.

It is a further object of the invention to provide for inducement of desired failure modes or indication of likely failure of an object after it is placed in service.

In order to accomplish these and other objects of the invention, a method of forming an indicia or marker within an additively manufactured object from fused powder is provided comprising steps of digitizing geometry of a prism portion of the indicia or marker, digitizing geometry of an identifier portion of the indicia or marker, performing Boolean subtraction of the digitized geometry of the identifier portion from the digitized geometry of the prism portion yield a first signal for controlling printing of layers of the object, printing and densifying a layer of the object and a layer of the prism portion having apertures corresponding to the geometry of the identifier portion of the indicia or marker, and filling the apertures with fusible powder material.

In accordance with another aspect of the invention, an indicia or marker for an object and an object including the indicia or marker are provided, the indicia or marker including a layer of material formed in the a of said object, wherein a portion of said layer of material of the indicia is densified to a density different from a density of a remainder of the object.

### BRIEF DESCRIPTION OF THE DRAWINGS

The foregoing and other objects, aspects and advantages will be better understood from the following detailed description of a preferred embodiment of the invention with reference to the drawings, in which:

FIG. 1A is a schematic depiction of a 3-D printer showing control of parameters that are preferably controllable for practicing the invention,

FIG. 1B is an illustration of a cross-section of a melt pool including preferred relative dimensions of a powder pattern and melt pool produced during additive manufacturing 1A,

FIG. 1C is a flow chart of the methodology of the invention,

FIGS. 2A, 2B and 2C are images of a test object including an image area, a computerized tomography (CT) section of the test object including the image area and the embedded computer-assisted design (CAD) of the image formed in the image area, respectively,

FIGS. 3A, 3B and 3C are images of an image area design, an image of the image area imaged by forward-looking infrared (FLIR) radar and detection of the indicia by sensing of differential cooling/heating rates, respectively,

FIGS. 4A, 4B, 4C, 4D and 4E are preferred types of identifier/indicia images that can be produced in the practice of the invention,

FIG. 5 is an isometric semi-transparent view of an image produced by practice of the invention to illustrate the definition of the geometry of the image,

FIGS. 6A and 6B illustrate the top or plan view of a preferred identifier image and an isometric partially transparent view of the image as formed by Boolean subtraction to form cavities,

FIG. 7A is an isometric view of a partially cut-away of the preferred image of FIG. 5 as formed by the invention,

FIGS. 8A, 8B, 9A and 9B illustrate different exemplary scan patterns which can be used and the results detected as a perfecting feature of the invention, and

FIGS. 10A, 10B and 10C are images of an identifier image, with and without image manipulation to verify the resolution of an image produced by practice of the invention.

### DETAILED DESCRIPTION OF A PREFERRED EMBODIMENT OF THE INVENTION

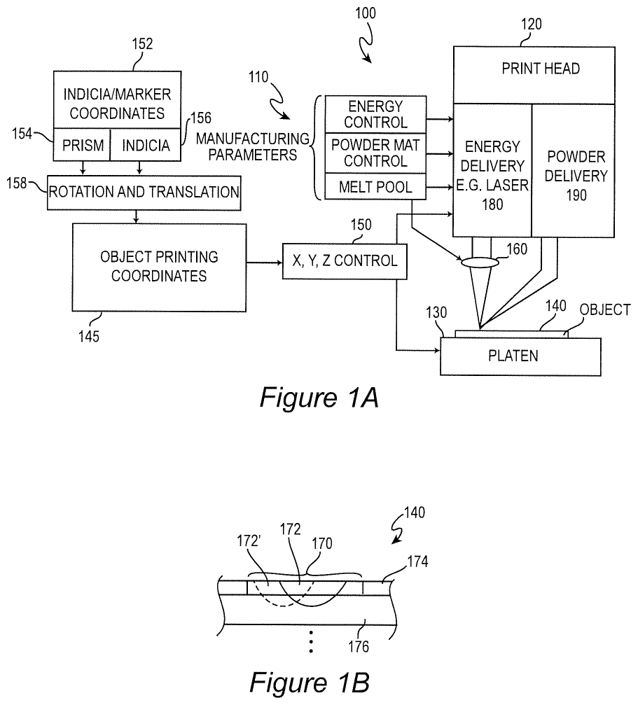

Referring now to the drawings, and more particularly to FIGS. 1A and 1B, there is shown a schematic depiction of a 3-D printer 100 having control of printing parameters 110 suitable for practice of the invention. It will be helpful to an understanding and appreciation of the invention in all its various aspects to keep in mind that the indicia or marker in accordance with the invention is entirely formed in the course of forming an arbitrary object by additive manufacturing and is achieved by manipulation of the density and/or grain microstructure of the material deposited during the deposition and consolidation of respective regions of each layer.

In this regard, it should be understood that words or expressions that are relative, such as small, proximate, substantially or the like are intended to be considered as indicating that variation from an optimum value is possible within the scope of the invention as long as the variation is sufficiently close to an optimum or preferred value that some meritorious effects of the invention are observable. Therefore, particular quantitative limits on the parameter to which such a word or expression applies need not be specified in this description or the appended claims to allow reasonable determination of the scope of the invention.

Returning to FIG. 1A, it should be understood that while control of all printing parameters 110 is preferred, the invention can be practiced to produce its intended meritorious effects by control of less than all printing parameters or even no printing parameter control at all as long as the parameters that cannot be controlled are at least known or calibrated so that the printer can be controlled to produce the images and indicia patterns desired or appropriate to a given application, object or function. In general, the inability to control one or more process parameters places limits on the minimum lateral dimensions of the indicia or marker that can be produced and may limit the thickness of a given layer that contains a layer of the indicia or marker that can be produced as will be more fully understood from the following discussion of FIGS. 1A and 1B.

The additive manufacturing or 3-D printing apparatus schematically illustrated in FIG. 1A comprises a printing head 120 for applying sequential layers of material, a platen 130 on which the object 140 to be manufactured is formed and a scanning arrangement 150 to move the printing head and platen in orthogonal directions (e.g. X, Y and Z) relative to each other. That is, the printing head is relatively moveable in a plane relative to the platen while the distance from the printing head to the platen is adjustable, at least incrementally, to compensate for the thickness of each layer of material as it is deposited. As will be understood by those skilled in the 3-D printing art, the scanning arrangement need not be entirely mechanical and may not involve relative movement of the printing head and platen since some scanning can be effectively performed by adjustments of powder and heat trajectory and printing head to platen distance with, for example, electronic deflection (e.g. electrostatic or with mirrors) and focusing (e.g. magnetic electron beam focus or wire/electrode feed gap to maintain a uniform arc discharge).

Referring now to FIG. 1B, the preferred relative sizes of the powder application pattern 170 and the melt pool 172 in a powder layer 174 on previously deposited material layer 176 created by the energy source are illustrated. It should be understood that the indicia produced in accordance with the invention involve manipulation of density of the material from which an object is additively manufactured. Therefore the mechanical properties of the material are likely to be locally altered to some finite degree by the indicia or marker formed in accordance with the invention. Therefore, it is generally desirable that the indicia be formed wholly within a non-critical portion of the object being additively manufactured that will have very little, if any, effect on the performance or intended purpose of the object. This consideration generally favors placement of the indicia or marker near the surface of the object. Such a location also favors the ability to detect and read the indicia or marker with best resolution. In the case of inducing a predictable failure mode, it is desirable that the location of the predictable failure be precisely located where a relatively harmless failure is to occur prior to any other failure mode of the object. Both of these considerations favor the indicia being formed at as small a size as is consistent with inspection of the object for the indicia.

The minimum size of identifiable indicia that can be formed is dependent on the dimensions (e.g. diameter and depth) of a melt pool i72 which, in turn, is dependent on the localization of the application of energy to the fusible powder. Therefore, a laser or an electron beam are slightly preferred to a wire feed electrode of small diameter that can still carry sufficient current to create an arc discharge. The diameter of the powder application pattern 170 should be at least equal to the diameter of the melt pool 172 and, in practice, is preferred to be twice the diameter of the melt pool as shown in FIG. 1B. As will be discussed in greater detail below, it is important to the practice of the invention to provide a margin or clearance of applied powder at the boundary of the indicia or marker being formed to prevent the mixing of material forming the indicia in a molten state with the surrounding material. While it is desirable that the margin be very narrow to limit effects of the indicia or marker on the material of the object, it has been found that the width of margin that is approximately one-half (e.g. 50%) of the diameter of the melt pool, while not critical, is generally adequate to the practice of the invention and an optimum dimension can be empirically determined for particular materials without undue experimentation. Such a dimensional relationship between the powder application pattern and the melt pool size is a major convenience for control of the additive manufacturing/3-D printer since it allows formation of margins of proper proportions/size using the same scanning pattern for both the powder application arrangement and the energy source.

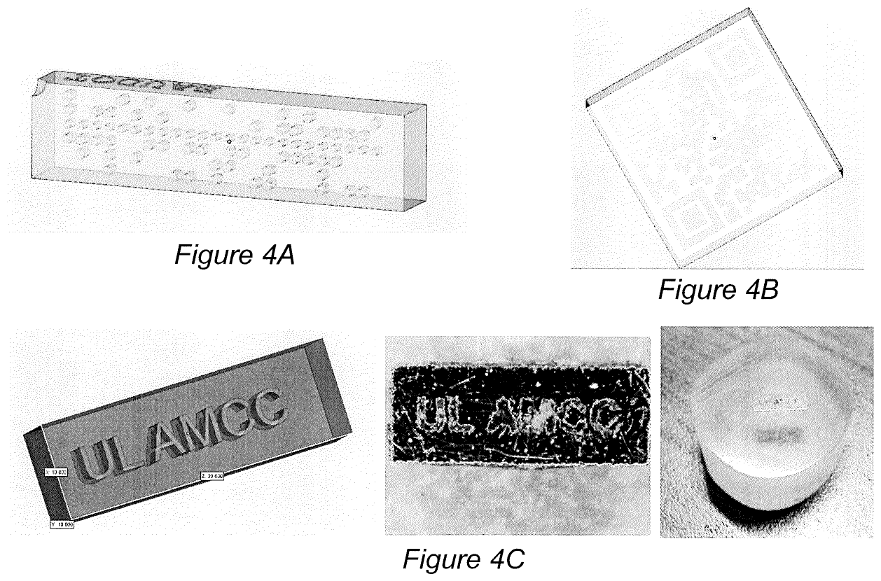

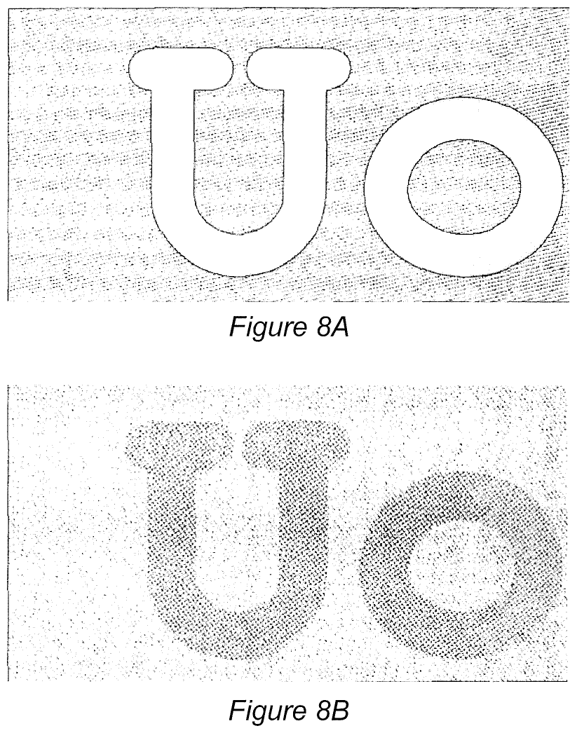

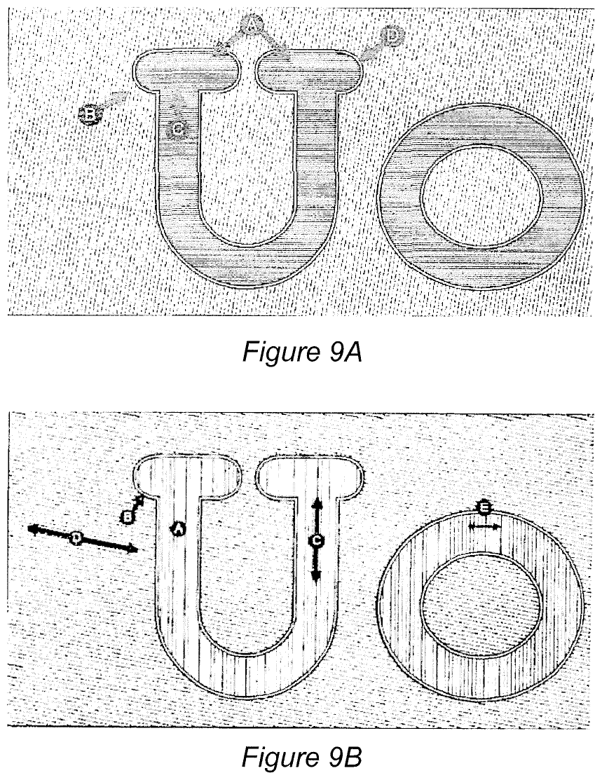

Indicia or marker width is also substantially arbitrary but should usually be at least a small multiple of the melt pool diameter for reliable observation and identification of an indicia or marking that has been formed in accordance with the invention and will be discussed in greater detail below in connection with perfecting features of the invention illustrated in FIGS. 8A-9B. Typical minimum dimensions of alphanumeric indicia formed by practice of the invention and which will be discussed in connection with FIGS. 5-7B include a margin of 0.075 mm and a melt pool diameter of 0.15 mm. As will be discussed below, an indicia or marker in accordance with the invention can be made much smaller and identifiable indicia have been formed as small as 0.3 mm. Thus, indicia formed in accordance with the invention can be placed in small, non-critical areas of a wide variety of objects and which may be quite small.

It is, of course, necessary that the indicia or markings formed in accordance with the invention be conveniently detectable and observable even when embedded within an additively manufactured object which otherwise conceals the indicia from being directly viewed. This counter-intuitive, concealment from view of the indicia is an important and meritorious effect of the invention in regard to counterfeit objects since it is not apparent from visual inspection that any indicia is present while even the location of the indicia within the additively manufactured object can be used to authenticate the object as genuine or as an indication of improper use conditions or approaching a failure mode. For example, a bolt-like fastener designed to be installed and tightened to a particular torque has been fabricated and excess torque applied. The use of excess torque has been detected even with the bolt-like fastener in place by the embedded indicia being moved to a slightly different location due to plastic and/or elastic deformation of the bolt-like fastener. Similarly, an increased likelihood of failure could be detected by distortion or movement of an indicia or marking due to accumulated plastic deformation.

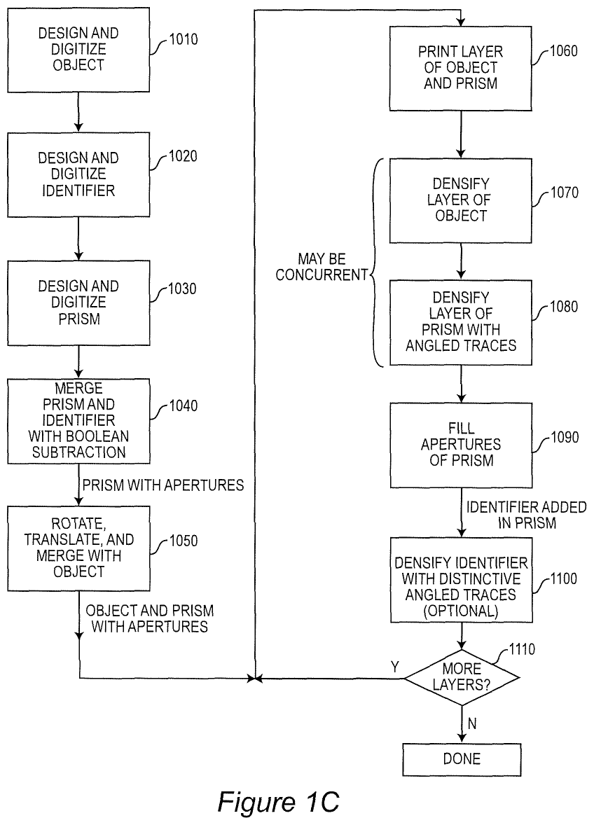

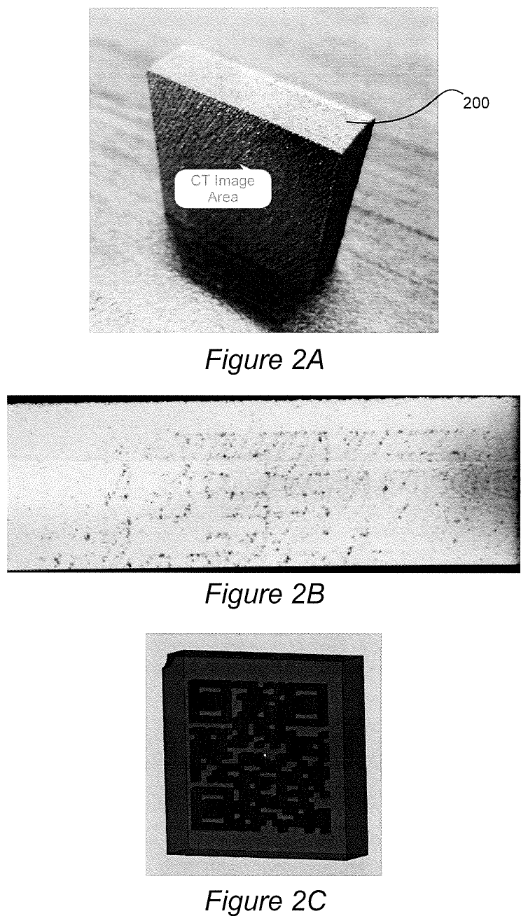

FIGS. 2A-2C and 3A-3C are images of proof of concept experiments to ascertain the ability to detect and identify indicia formed in accordance with the invention using known and convenient detection techniques and apparatus. FIG. 2A illustrates a test block of metal material measuring 20 mm×20 mm×5 mm formed by additive manufacture. A pattern of indicia as shown in FIG. 2C, derived by computer aided design (CAD) as shown in FIG. 2C was formed within the block. The block was then probed with a medium such as ultrasound which is a well-understood and mature technology and can be applied using a small and easily manipulated probe. The signals thus derived were processed by computer tomography (CT) to observe a section of the block at a 3 mm depth (at the approximate center of the block); a small region of which is shown in FIG. 2B. The rectilinear pattern is clearly visible.

FIG. 3A is an image of a test block similar to that of FIG. 2C where the indicia or marking has been concealed by an additional layer or layers overlying a small CAD pattern. The test block of FIG. 3A is of uniform temperature and neither the location nor shape of the indicia or marking is apparent. However, when a significant (e.g. 11° C.-238° C. in FIG. 3B) temperature gradient is applied across the thickness of the test block, the location of the pattern becomes apparent as a rectangular shape with a margin using forward-looking infra-red (FLIR) radar detection in which heat is applied from the back of the test block causes increased reflection with increased temperature. The differential in density and/or composition and/or grain structure of the indicia or mark produces a differential thermal resistance in the material of the indicia or marker which alters the temperature gradient within the test block that can be at least detected by FLIR radar. It is possible to perform similar indicia or mark location detection with any thermal imaging technique having resolution comparable to the dimensions of the indicia or marking.

If a greater thermal gradient (e.g. −17° C.-330° C.) is applied across the thickness of the test block, resolution is improved and FLIR radar imaging begins to show some detail of the indicia or marking as shown in FIG. 3C. While the resolution of the image of FIG. 3C is not considered adequate for all purposes contemplated for the invention, a higher resolution FLIR system should yield satisfactory results.

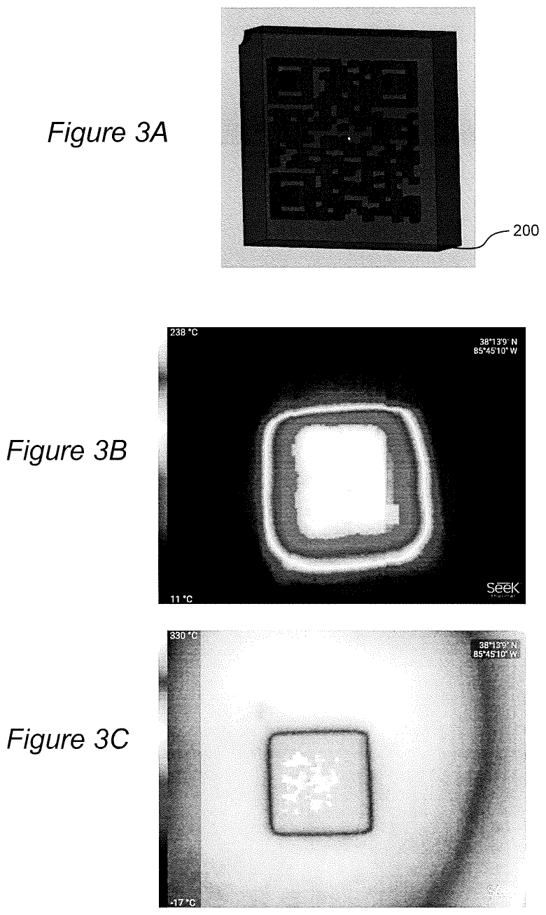

The indicia or marker produced in accordance with the invention is not at all limited to the rectilinear CAD pattern of FIGS. 2A-3C but can be of any two-dimensional or three-dimensional pattern compatible with a desired region of the object to be additively manufactured and can be coded in any known of foreseeable pattern for object identification, serial number and/or particular characteristics (e.g. material, design tolerance, date of production, etc.) For example, FIG. 4A illustrates coding referred to as Baudot code which is comprised of a line of spaced cylindrical index “dots” which indicate locations laterally displaced therefrom where larger data “dots” may or may not be placed to represent, in coded form, any desired information. Bar coding could also be employed in the same manner, FIG. 4B show yet another form of coding referred to as a quick response (QR) code that may be as extensive as desired to accommodate desired information. FIG. 4C is an image of alphanumeric characters as designed and printed. FIGS. 4D and 4E show images of indicia or marking that has been sectioned, polished, etched and re-polished which can be performed to render the indicia or marking visible if desired. Even if made visible, the difference in material and/or increased density or grain orientation achievable in accordance with the invention will provide increased durability of the indicia or marking since the indicia or marking extends for a non-critical depth within the body of the object and may be as great as desired. By the same token, it should be appreciated that the indicia or marking can vary in shape from layer-to-layer in the additively manufactured object and thus can serve to indicate abrasion or wear of a surface of the object.

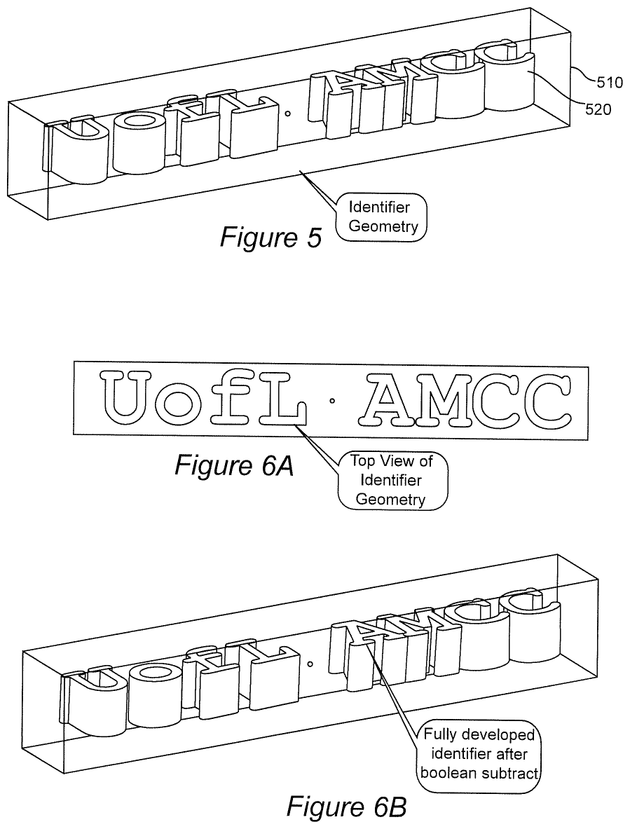

Referring now to FIGS. 5-6B, a preferred methodology for fabricating preferred form of the indicia or marking in accordance with the invention will now be discussed. As alluded to above, a non-critical volume of an additively manufacturable object that is adequate to contain the indicia or marking must be identified. (As used herein, the term “non-critical” is intended to convey that the region or volume is at a location where any change in the physical properties of the material comprising the indicia or mark will not affect the function or properties of the object or will provide a predictable failure mode that will not be injurious or catastrophic during anticipated operating conditions although the function of the object may be compromised or prevented. It should be appreciated that the provision of a predictable failure mode may have utility in preventing use of an object in an undesirable manner such as a part of a weapon as well as providing avoidance of comparatively more dangerous or destructive failure modes.) The additive manufacturing/3-D printing apparatus must be able to deliver enough energy to fully densify and consolidate the material(s) used to manufacture the object and/or indicia or marking in accordance with the invention and the size of the melt pool must be known or designed. All of the other additive manufacturing parameters in regard to the indicia or marker in accordance with the invention are fundamentally related to each other by the size of the melt pool as will be apparent from the following discussion of the formation of the indicia or marker in connection with the flow char of FIG. 1C.

It will be initially noted that the flow chart of FIG. 1C is arranged in two columns. The column on the left illustrates the design and processing required to develop digital instructions for controlling the additive manufacturing apparatus/3-D printer schematically illustrated in FIG. 1A while the column on the left illustrates the sequence of operations automatically performed by the additive manufacturing apparatus/3-D printer. While not critical, such a division of the methodology of the invention is much preferred since it allows the indicia or marker produced by the invention to be easily modified or iteratively changed during a manufacturing run such as for application of serial numbers, manufacturing time/date and the like; which changes can be programmed to be performed automatically.

Of course, the object to be additively manufactured must be designed and digitized as shown at 1010 regardless of whether or not an indicia or marker in accordance with the invention is to be included. If the indicia or marker is to be included, a non-critical volume of the object must be chosen or designed as part of this operation. The prism and identifier portions of the indicia or marker are then similarly designed and digitized as depicted at 1020 and 1030. It is preferred that these operations, 1020, 1030, be performed as an interleaved set of actions since the non-critical volume of the object imposes a limit on the dimensions of the prism while the prism should be large enough to encapsulate the identifier which, in turn, preferably has dimensions which are at least a multiple of the melt pool diameter as will be discussed in greater detail below. Otherwise, the geometry of the indicia or marking is completely arbitrary and may be freely designed and digitized to control the additive manufacturing/3-D printing apparatus.

Preferably, all additive manufacturing parameters are controllable but any that are not controllable in a particular 3-D printing apparatus must be accurately known, especially the dimensions of the melt pool. The indicia/marker geometry should be of sufficient dimensions in plan view (e.g. FIG. 6A) to be easily imaged or read with available instrumentation. The thickness of the indicia or marking should be a multiple of the thickness of layers that can be produced by the additive manufacturing/3-D printing apparatus. Two separate geometries must be defined for forming the indicia or marking: the first is basically a rectangular prism within the volume of the object to be additively manufactured and the second is an arbitrary desired and preferably unique pattern of suitable dimensions to be contained within the rectangular prism and may be referred to as the identifier to distinguish it and its geometry from that of the prism. (The term “indicia or marker” is used herein to collectively refer to the prism and identifier.) In the indicia shown in FIGS. 5-9B, the prism dimensions were X=60 mm, Y=8 MM and Z=12 mm and is the acronym for the University of Louisville Additive Manufacturing Competency Center (UofL AMCC). The font (Courier bold) size is 10 mm tall and 5 mm thick. The geometries of the identifier and prism are then merged by Boolean subtraction of the identifier from the prism (to effectively form apertures in layers of the prism, as shown in FIG. 6B when printed), as depicted at 1040. The geometry of the identifier is also separately maintained and used to fill the apertures formed in each layer of the prism and, later, to densify the material of the identifier.

These geometries of the indicia or marker are then digitized, rotated (e.g. compare the plan view of FIG. 6A and the view in FIG. 6B—the indicia or marker should face the direction from which it will be detected and/or imaged) and translated to the desired position of the non-critical volume within the geometry of the object. The digitized geometry of the indicia or marker is then merged with the digitized data representing the object, as depicted at 1050. It should be appreciated that all of this geometry definition, including the object to be manufactured, is performed in the data prior to the 3-D printing process, as shown on the right side of FIG. 1A. This allows the indicia or marker to be formed during the normal 3-D printing process for the object, itself and requires only separate scanning of the area occupied by the identifier (to deposit and densify the material of the identifier which has been filled into the apertures in a layer of the prism) which, as alluded to above, is preferably very small. Therefore, the time required for additive manufacture of an object is not significantly increased by the formation of the indicia or marker in accordance with the invention.

Once the additive manufacturing apparatus/3-D printer control data has been prepared, material to form a layer of the object and prism is deposited, as illustrated at 1060 followed by densification 1070 of the layer of the object and the densification of the layer of the prism, respectively. Deposition of the material of the object and the material of the prism can be performed in a single step even if different materials are used for the object and the prism but different materials can be separately deposited, depending of capabilities of the additive manufacturing/3-D printing apparatus. Then, the material of the object and the material of the prism are respectively densified 1070, 1080 by forming a melt pool and scanning the melt pool across the respective areas of the layer. Since the melt pool is preferably very small it can be formed almost instantaneously by application of sufficient energy. Cooling is also very rapid behind the melt pool as the melt pool is moved across the layer. These densification operations are depicted separately in FIG. 1C since the level of energy applied, the rate of scanning, the offset between traces of the melt pool path and the pattern of the melt pool scanning, as will be discussed in greater detail below, will preferably differ between the object portion and the prism portion of the layer, particularly if the same material is used for both the object and the prism. However, these operations can also be performed concurrently, by altering manufacturing parameters in accordance with the respective areas of the layer in an interleaved fashion.

Completion of steps 1060-1080 results in a layer of the object having areas of differing density and grain microstructure and, possibly, materials with apertures in the shape of the identifier. The layer of indicia or marker in accordance with the invention is then completed by filling the apertures in the prism with the desired material (1090) and, optionally, densifying it; again with a melt pool trace pattern that is preferably distinctive from the densification of the object and prism. In this regard it is preferred that the material of the identifier be densified to a density that is greater than that of the prism which, in turn is greater than that of the remainder of the object. The preferred differences in density will result in optimum visibility when the indicia or marker is imaged but other orders of density of the respective regions of the layer can also be used if the magnitude of the density difference between them is sufficient and the indicia or marker is sufficiently close to a surface of the object even though material of a greater density will tend to mask material of lesser density overlying it. By the same token, while the invention can be practiced using only one layer for the indicia or marker, the ability to image the indicia or marker may be compromised, particularly using thermal techniques. In any case, the margins between these regions or the melt pool scanning trace pattern can usually be imaged if of sufficient size and/or width.

It is then determined at 1110 if more layers are to be printed to complete the indicia or marker and the remainder of the object. If so, the process loops back to step 1060 and the process repeated until the object is completed. In this regard, it should be noted that layers of the object underlying the indicia or marker are printed while omitting steps 1070-1100 and at least one similarly produced layer should preferably overly the indicia or marker if the indicia or marker is to be fully embedded and concealed in the object.

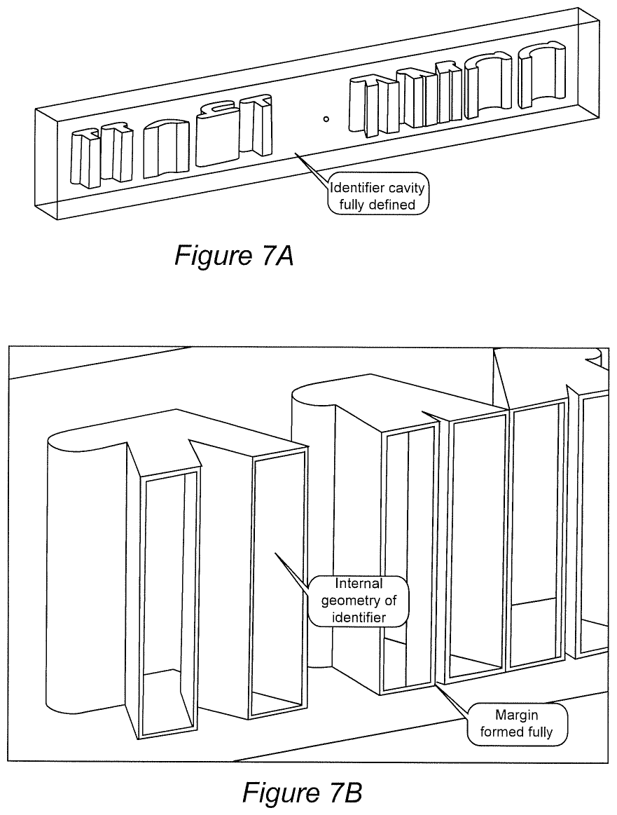

To summarize the results of the above-described methodology, FIG. 7A is a rendering of a semi-transparent, partially cut-away view of a portion of the object containing the indicia or marker formed in accordance with the invention and prior to filling and densification of the apertures or cavities within the prism. FIG. 7B is an enlarged portion of a portion of the volume represented in FIG. 7A but after filling and densification of the identifier. The portion of FIG. 7A shown in FIG. 7B comprises the upper portion of the letter “A” and part of the letter “M”. It should be noted that the margin appears in FIG. 7A as a single line indicating an edge or margin of partially densified powder material. In FIG. 7B, two lines appear at the margin which result from the separate and subsequent filling and densification of the identifier.

Referring now to FIGS. 8A-9B the perfecting feature of the invention, alluded to above, will now be explained. It will be recalled from the illustration and discussion of FIG. 1B that the melt pool extends through the layer of powder material and into the previously formed material layer to the extent that sufficient heat of fusion is conducted to raise the material to a temperature at which it becomes molten. The amount of densification achieved at any location within the melt pool when the molten material again solidifies will generally correspond to the maximum temperature reached. Since the transverse dimension of the melt pool is very small and the energy deliverable by the additive manufacturing apparatus/3-D printer is relatively large, this temperature can be reached and the melt pool formed very quickly such that the melt pool can be scanned to produce a trace of material that has been densified. Therefore there will be a relatively sharp temperature gradient at the boundary of and within the melt pool and a substantial gradient of density across a completed trace will result which can be observed by the techniques described above in connection with FIGS. 2A-3C.

Since it is preferred that the width of an identifier of indicia or markings produced in accordance with the invention be at least several times the diameter of the melt pool or transverse dimension of a trace, a plurality of traces offset from each other must be formed to densify the width of an identifier or prism. While a relatively uniform densification can bee achieved by overlapping traces by 50% or more, a reduced overlap of traces will yield an observable pattern or texture of a pattern of density differentiating the identifier from the prism that can also serve to authenticate an indicia or mark and can even contain a small amount of coded information. FIGS. 8A-9B are exemplary of few of the many patterns or textures that can be achieved in accordance with the invention even without modulation of the densifying energy which can also be used.

FIG. 8A illustrates using parallel traces similar to a raster scan at an angle to the side surfaces of a prism for prism layer densification and a lesser but more uniform densification of the identifier portion. Note that angled scanning clearly outlines the outside margins of the identifier. FIG. 8B illustrates a similar but more greatly angled scanning of the prism layer and a second angled scanning with reduced overlap in the identifier to produce a cross-hatch pattern in the identifier. In this case, the margins between the identifier and prism have been effectively erased without compromising the sharpness of the outside contours of the identifier while the margins at the boundary of the prism remain sharp and clearly defined. Such margin erasure may be useful if mechanical integrity across the indicia or marker is of importance.

As alluded to above, the invention is considered to comprehend manipulation of material microstructure such as grain size and orientation. Such manipulation can be achieved through manipulation of fusion energy, scanning speed, thermal conductivity and other ambient conditions. FIG. 9A shows scanning of the identifier and the prism in substantially orthogonal directions so that an alteration of the microstructure can be clearly observed. As with FIG. 8A, angled scanning tends to emphasize observability of margins. FIG. 9B with differently angled scans for the identifier (A) and the prism (D) is similar to FIG. 9A but uses a constant offset or overlap for both the prism (D) and identifier or core (A). The margins thus provide an observable contour (B) and average density can be controlled or even coded to a degree by control of trace offset in direction (E). By the same token, it should be appreciated that scanning is not limited to a raster of parallel linear traces but other scanning patterns such as rotating vector scanning, scanning parallel to identifier contour and the like could be used to develop other observable patterns and textures. Many other variations and combinations thereof will become apparent to those skilled in the art.

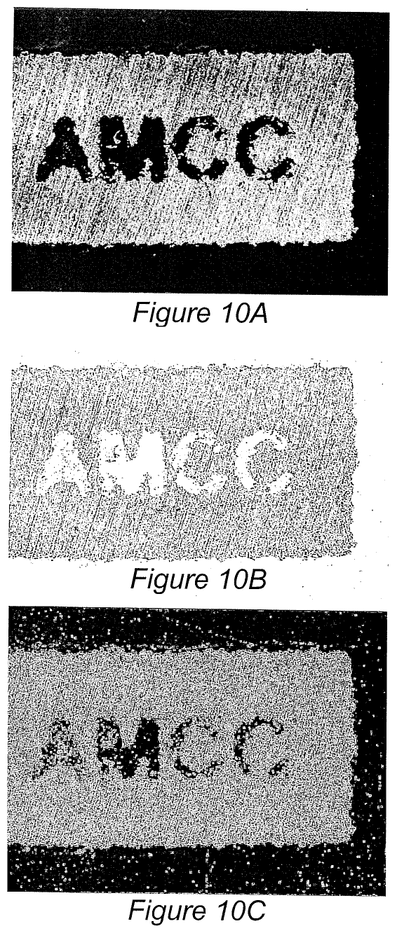

To demonstrate the efficacy of the invention and to verify fidelity at very small scale, a sample indicia or marker in accordance with the invention was prepared in 17-4 stainless steel with overall prism dimensions of 8 mm×3.5 mm×2 mm with identifier characters 1.3 mm in height and a thickness or depth of 40 microns. The surface of the sample was then sectioned and ground to reach the identifier characters which are clearly visible and identifiable both to the naked eye and under microscopy; a raw image of which is shown in FIG. 10A. The substantial contrast observable in FIGS. 10A-10C is due to omitting of densification of the identifier portion of the indicia or marker. Much the same effect can be achieved by application of fusion energy at an angle to achieve a different degree of densification from that of the prism. It should be noted that the margins are also visible as clusters of grains and clearly authenticate the indicia or marker as having been formed in accordance with the invention, Therefore, the invention is capable of providing serial numbers or printer identification of a size that have negligible effect of the properties or performance of an object and nearly undetectable size in the absence of knowledge of their presence and virtually impossible to duplicate in a previously fabricated object.

As noted above, FIG. 10A is a raw image that has not been manipulated. The high contrast and fidelity which is characteristic of images of the indicia or marking even after processing with relatively low gray-scale resolution. For example, FIG. 10B and 10C have been processed with 8-bit resolution and not threshold; FIG. 10 B being additionally inverted. Therefore the indicia or markings provided by the invention are adequate for automated inspection of tracking such as block chain accounting and monitoring.

In view of the foregoing, it is clearly seen that the invention provides for enhanced security, and serial number and other information, authentication and traceability of origin, anti-counterfeiting measure and monitoring over extended periods of time in service about the object in which it is formed. It is also capable of providing for predictable and relatively harmless failure modes as well as information about proper use conditions. Additionally, the indicia or marker in accordance with the invention can be provided in any object or structure that includes a plurality of layers such as a weld formed of a plurality of overlaid weld beads as in automated welding.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A method of forming an indicia or marker within an additively manufactured object from fused powder, said method comprising steps of
digitizing geometry of a prism portion of said indicia or marker,
digitizing geometry of an identifier portion of said indicia or marker,
performing Boolean subtraction of said digitized geometry of said identifier portion of said indicia or marker from said digitized geometry of said prism portion of said indicia or marker to yield a first signal for controlling printing of layers of said object,
printing and densifying a layer of said object and a layer of said prism portion, said layer of said prism portion of said object having apertures or cavities corresponding to said geometry of said identifier portion of said indicia or marker, and
filling said apertures or cavities with fusible powder material.

2. The method as recited in claim 1, including a further step of densifying a portion of said fusible powder material in said apertures, leaving a margin of unidentified powder material at an outside edge of said geometry of said identifier portion.

3. The method as recited in claim 2 wherein a portion of said identifier and a portion of said prism are densified to different densities

4. The method as recited in claim 1, wherein a portion of said object and a portion of said prism are densified to different densities.

5. The method as recited in claim 1, wherein said material of one of said object, said prism and said identifier is a metal or metal alloy.

6. The method as recited in claim 1, wherein said material of one of said object, said prism and said identifier differs from material of another one of said object, said prism and said identifier.

7. The method as recited in claim 1, wherein said densifying is performed by scanning a melt pool of a layer of said indicia or marker to form a plurality of traces in a pattern,

8. The method as recited in claim 7, wherein said pattern of traces differs between said identifier and said prism.

9. The method as recited in claim 7, wherein said pattern of traces forms a margin between said identifier and said prism or between said prism and a remainder of said object.

10. The method as recited in claim 1, said method including the further step of forming and densifying a layer of said object over said indicia or marker.

11. An indicia or marker for an object, wherein said object includes a plurality of layers, said indicia or marker including a layer of material formed in a said layer of said object, wherein a portion of said layer of material of said indicia is densified to a density different from a density of a remainder of said object.

12. The indicia or marker as recited in claim 11, wherein said layer of material of said indicia is formed with apertures.

13. The indicia or marker as recited in claim 12, wherein said apertures are filled with a powder material.

14. The indicia or marker as recited in claim 13, wherein said powder material is densified to a density distinct from said density of said layer of material of a remainder of said indicia.

15. An object including an embedded marker, said object being formed to include a plurality of layers and including an indicia or marker wherein said marker or indicia includes a layer of material formed in a layer of said object, wherein a portion of said layer of material of said indicia is densified to a density different from a density of a remainder of said object.

16. The object as recited in claim 15, wherein said layer of material of said indicia is formed with apertures.

17. The object as recited in claim 16, wherein said apertures are filled with a powder material.

18. The object as recited in claim 17, wherein said powder material is densified to a density distinct from said density of said layer of material of a remainder of said indicia.
